(19) United States
(12) Patent Application Publication
(10) Pub. No.: US 2011/0277853 A1
(43) Pub. Date: Nov. 17, 2011

(54) VALVE LOCKOUT DEVICE

(75) Inventor: Gary R. Burmesch, Port Washington, WI (US)

(73) Assignee: MASTER LOCK COMPANY LLC, Oak Creek, WI (US)

(21) Appl. No.: 13/105,354

(22) Filed: May 11, 2011

Related U.S. Application Data
(60) Provisional application No. 61/333,488, filed on May 11, 2010.

(51) Int. Cl. F16K 35/00

(52) U.S. Cl. 137/383

(57) ABSTRACT

A valve assembly is provided in combination with a valve lockout device. The valve assembly includes a valve body, a valve handle, and first and second ports connected with corresponding first and second conduits. The valve lockout device includes a frame member secured to the valve, a shroud member assembled with the frame member, and a locking mechanism secured to the frame member. The frame member and shroud member define an enclosure enclosing the valve. At least one of the frame member and shroud member at least partially defines a first opening positioned to receive the first conduit therethrough, and a second opening positioned to receive the second conduit therethrough. The locking mechanism is operable between a locked condition in which the shroud member is secured to the frame member, and an unlocked condition in which the shroud member is removable from the frame member to access the valve.

### CROSS-REFERENCE TO RELATED APPLICATION

This application claims priority to, and any other benefit of, U.S. Provisional Patent Application Ser. No. 61/333,488, entitled VALVE LOCKOUT DEVICE and filed May 11, 2010, the entire disclosure of which is fully incorporated herein by reference.

### BACKGROUND

Many security devices are provided for restricting access to equipment and control instruments, including, for example, electrical components, such as switches, dials and push buttons, and fluid system components, such as valves and pressure regulators. One exemplary security device is a valve lockout device configured to prevent the operation of a valve. The valve lockout device may be utilized during maintenance of the associated fluid system or under other conditions in which the flow setting of the valve must not be changed.

### SUMMARY

According to an exemplary embodiment of the present application, a lockout device for restricting access to an item includes a frame member, a shroud member, and a locking mechanism. The shroud member is configured to be assembled with the frame member, such that the frame member and shroud member define an enclosure sized to enclose the item. The locking mechanism is secured to the frame member and is operable between a locked condition in which the shroud member is secured to the frame member, and an unlocked condition in which the shroud member is removable from the frame member to access the item. The shroud member includes a lock access aperture aligned with a lock interface of the locking mechanism when the shroud member is assembled with the frame member. The lock interface is spaced apart from the lock access aperture by a portion of the enclosure to inhibit tampering with the lock interface.

According to another exemplary embodiment of the present application, a valve lockout device is provided for assembly with a valve having a first port connected with a first conduit and a second port connected with a second conduit. The device includes a frame member configured to be secured to the valve, and a shroud member configured to be assembled in sliding engagement with the frame member. The frame member and shroud member define an enclosure sized to enclose the valve. At least one of the frame member and shroud member at least partially defines a first opening positioned to receive the first conduit therethrough, and a second opening positioned to receive the second conduit therethrough. A locking mechanism is secured to one of the frame member and the shroud member and is operable between a locked condition in which the shroud member is secured to the frame member, and an unlocked condition in which the shroud member is removable from the frame member to access the valve when the valve lockout device is installed on the valve. The locking mechanism includes at least one locking member that extends into a corresponding recess in the other of the frame member and the shroud member when the locking mechanism is in the locked condition. The at least one locking member is retractable from the corresponding recess when the locking mechanism is in the unlocked condition.

According to still another exemplary embodiment of the present application, a valve assembly is provided in combination with a valve lockout device. The valve assembly includes a valve body, a valve handle for operating the valve, and first and second ports connected with corresponding first and second conduits. The valve lockout device includes a frame member secured to the valve, a shroud member assembled with the frame member, and a locking mechanism secured to the frame member. The frame member and shroud member define an enclosure enclosing the valve. At least one of the frame member and shroud member at least partially defines a first opening positioned to receive the first conduit therethrough, and a second opening positioned to receive the second conduit therethrough. The locking mechanism is operable between a locked condition in which the shroud member is secured to the frame member, and an unlocked condition in which the shroud member is removable from the frame member to access the valve.

### BRIEF DESCRIPTION OF THE DRAWINGS

Further features and advantages of the invention will become apparent from the following detailed description made with reference to the accompanying drawings, wherein:

FIG. 1 is a front view of an exemplary gas shutoff valve assembly;

FIG. 2A is an upper front perspective view of an exemplary valve lockout device;

FIG. 2B is a lower rear perspective view of the valve lockout device of FIG. 1;

FIG. 3 is a lower front perspective view of the valve lockout device of FIG. 1, shown with the shroud member disassembled from the frame member;

FIG. 4 is an exploded side perspective view of the valve lockout device of FIG. 1;

FIG. 5 is a rear elevational view of the valve lockout device of FIG. 1, shown with the back plate and latch cover removed to illustrate additional features of the device;

FIG. 6 is a lower perspective view of the shroud member of the valve lockout device of FIG. 1;

FIG. 7 is a perspective view of an exemplary valve lockout device assembled with an exemplary gas shutoff valve; and

FIG. 8 is a perspective view of the valve lockout device of FIG. 7, shown with the shroud member removed.

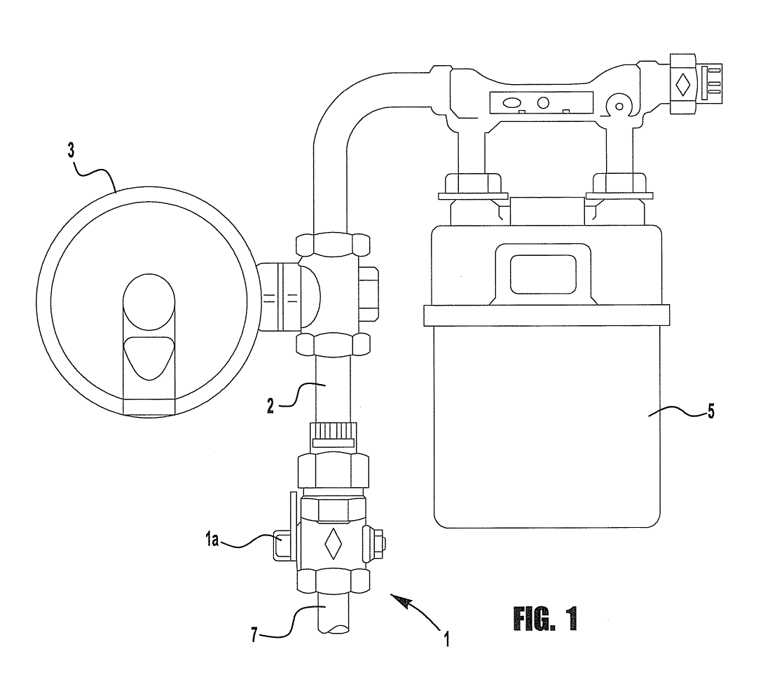

### DETAILED DESCRIPTION

This Detailed Description merely describes embodiments of the invention and is not intended to limit the scope of the claims in any way. Indeed, the invention as claimed is broader than and unlimited by the preferred embodiments, and the terms used in the claims have their full ordinary meaning.

Also, while the exemplary embodiments described in the specification and illustrated in the drawings relate to a lockout device for a gas meter valve, it should be understood that many of the inventive features described herein may be applied to other lockout devices, including, for example, lockout devices for other valves, and for other mechanical and electrical control instruments, conduits, and connections, and may also be used in other locking enclosures, including, for example, safes and lock boxes, for restricting access to other items.

In some embodiments, a valve lockout device may include a bracket, clamp, or cover that locks onto, over, and/or around a handle and/or body of a valve (e.g., by an inserted padlock or an integral locking mechanism, such as a key cylinder) to block operation of the valve handle. While many valve lockout devices are designed primarily to prevent inadvertent or undesired operation of a valve, for example, in a factory or laboratory setting, other applications require secure lockout of a valve against malicious or unauthorized attempts to defeat an installed lockout device for operation of the valve. One such example involves the lockout of natural gas valves used in residential and commercial locations in which gas service has been discontinued due to nonpayment of gas utility bills. In an effort to thwart these lockout arrangements, an individual may unlawfully open or operate a gas shutoff or metering valve by attacking the valve or the lockout device, for example, by cutting through the handle and/or the lockout device, by picking or otherwise defeating the locking mechanism, or even by drilling a hole into the valve body (often constructed of brass) upstream of the valve seat to divert the gas supply for unlawful use.

The present application contemplates a lockout device including a lockable shroud that may be secured around an item to which access is to be restricted or secured, for example, to prevent operation of, tampering with, or theft of the item. In one embodiment, the lockout device is adapted to be secured around a valve, thereby blocking access to one or both of the valve handle and the valve body to prevent unauthorized operation of, or tampering with, the valve. In an exemplary embodiment, a lockout device includes a bracket or frame member assembled with or secured to the valve, and a shroud member that lockingly engages the frame member to block access to the valve by partially or fully enclosing the valve. A locking mechanism securing the shroud member to the frame member may include a user operable lock interface, such as a key cylinder, combination dial, electronic interface (e.g., keypad, biometric sensor, etc.), or other such arrangement. Upon proper manipulation of the lock interface, the shroud member is removable from the frame member for access to and operation of the valve.

In an exemplary application, a gas meter valve 1 is assembled with a pressure regulator 3 and gas meter 5 outside a building (e.g., a residential, commercial, or industrial building) by a conduit 2. The pressure regulator and gas meter 5 are used to calibrate and measure the amount of gas supplied by a gas utility to the building. Where a termination of the supply of gas to the building is desired (for example, if a gas leak is detected, or if the gas utility bill has not been paid), the meter valve handle 1a may be operated to shut off the supply of gas from a source conduit 7. However, easy access to the gas valve by owners or residents of the building may prevent risks of operation of or tampering with the gas valve to improperly restore the supply of gas to the building.

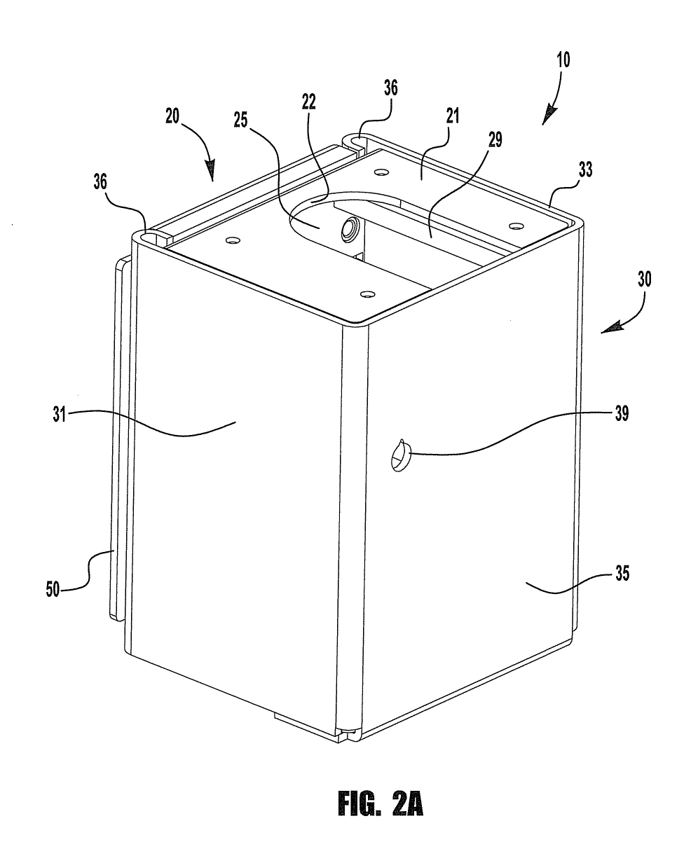

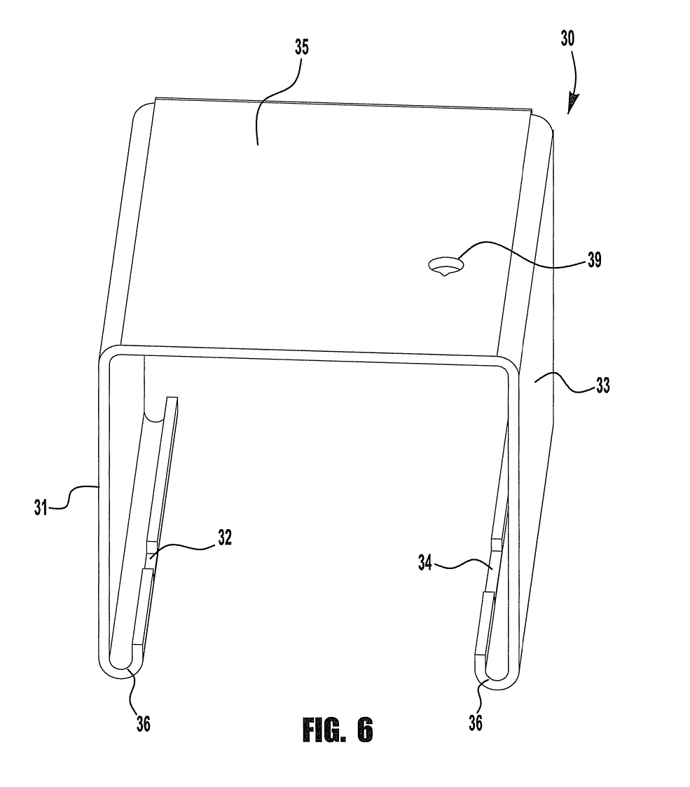

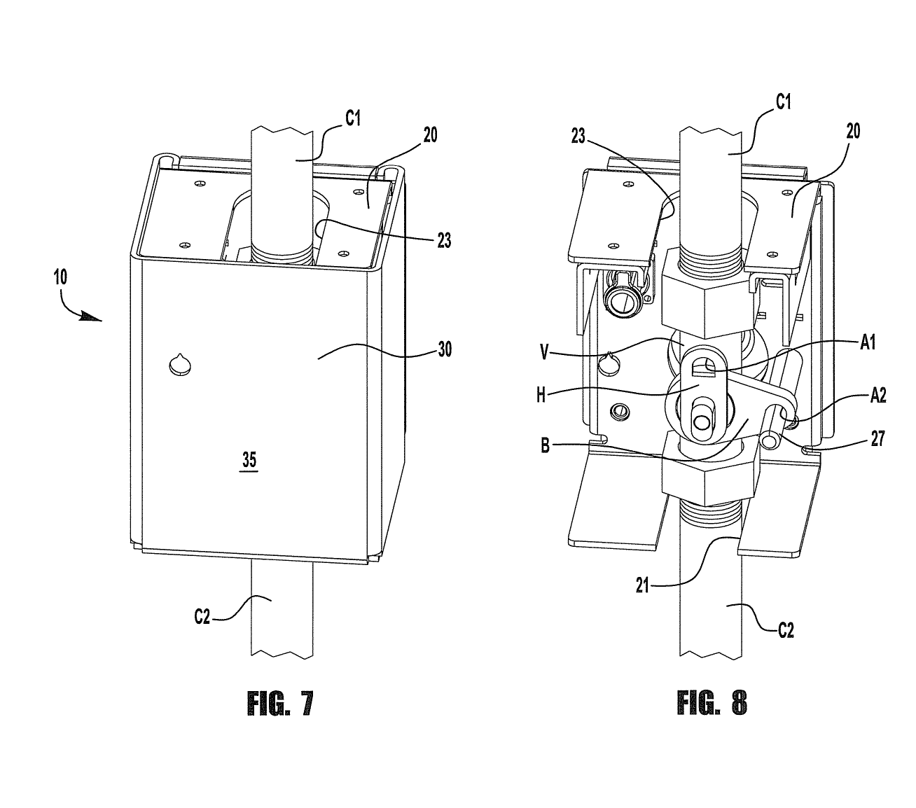

FIGS. 2A-8 illustrate various views of an exemplary valve lockout device 10 including a frame member 20 and a shroud member 30. The exemplary frame member 20 includes top and bottom wall portions 21, 23 defining one or more cut-out portions 22, 24 sized to receive one or more valve conduits C1, C2 therethrough (as shown in FIGS. 7 and 8), such that the frame member 20 may be assembled with an installed valve. In some embodiments (including the illustrated embodiment), the lockout device 10 may be assembled in any orientation accommodating the valve conduits C1, C2, and as such, the top wall portion 21 may face upward, downward (as shown in FIGS. 7 and 8), to the side, or any other suitable position. The exemplary shroud member 30 includes a front wall 35 and opposed side walls 31, 33. When assembled, the frame member 20 and the shroud member 30 define an enclosure sized to receive a valve V (FIG. 8) to be locked out. In other embodiments (not shown), the shroud member may include all or part of one or both of the top and bottom walls in addition to or instead of all or part of one or both of the side walls, and/or the frame member may include all or part of one or both of the side walls in addition to or instead of all or part of one or both of the top and bottom walls.

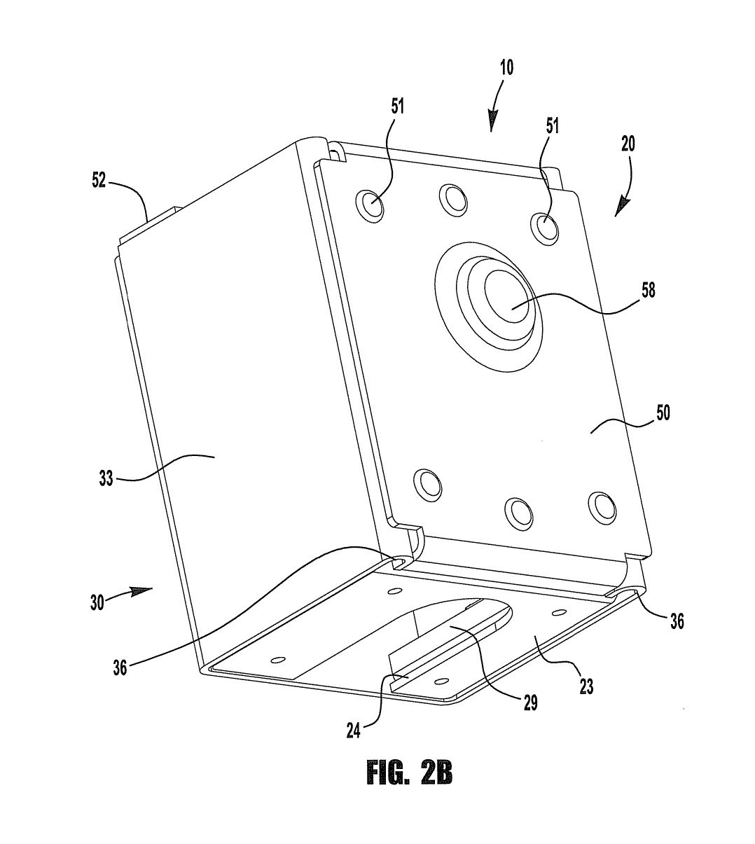

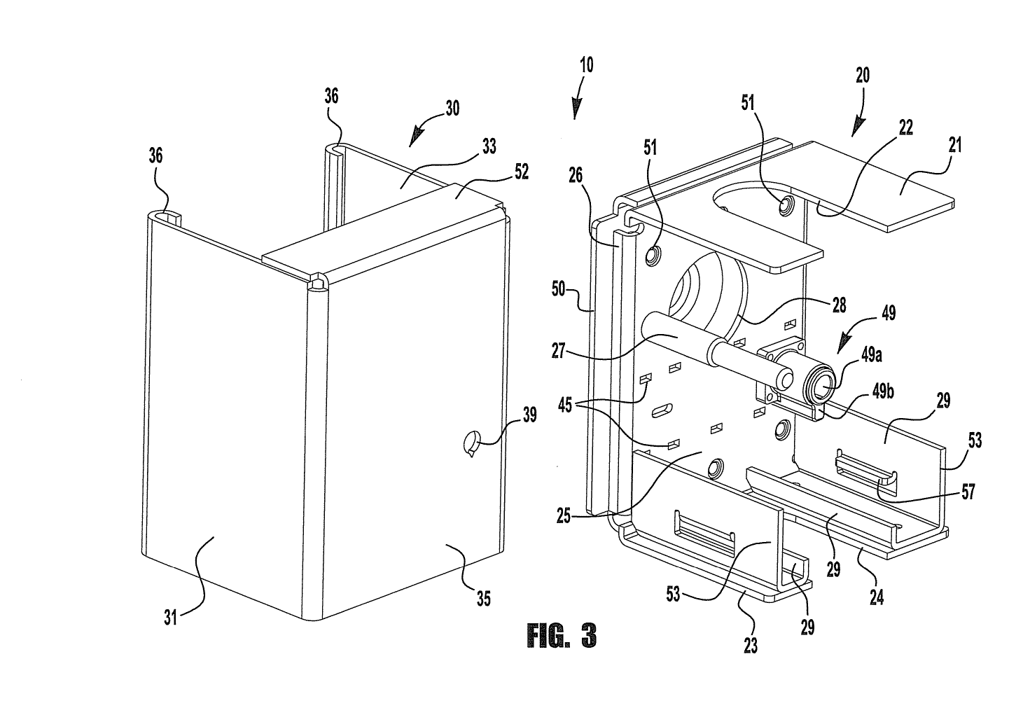

Gussets 29 or other such reinforcing members may be secured to, or integral with, the top and bottom wall portions 21, 23, for example, to provide increased rigidity and/or to impede access by an inserted tool. While the frame member and shroud member may be configured for assembly in many different arrangements, in the illustrated embodiment, the frame member 20 includes a rear wall 25 from which the top and bottom wall portions 21, 23 extend) having side flanges 26 (FIGS. 3 and 4) that fit into slotted bearing portions or grooves 36 along the side walls 31, 33 of the shroud member 30 for sliding engagement between the frame member and the shroud member. While the flanges 26 and slotted bearing portions 36 of the illustrated embodiment extend vertically for vertical sliding movement of the shroud member 30, other embodiments may utilize horizontal flanges and slotted bearing portions (or other sliding engagements) for horizontal sliding movement of the shroud, or horizontal axial (i.e., parallel to the side walls) flanges and slotted bearing portions (or other sliding engagements) for axial sliding movement of the shroud.

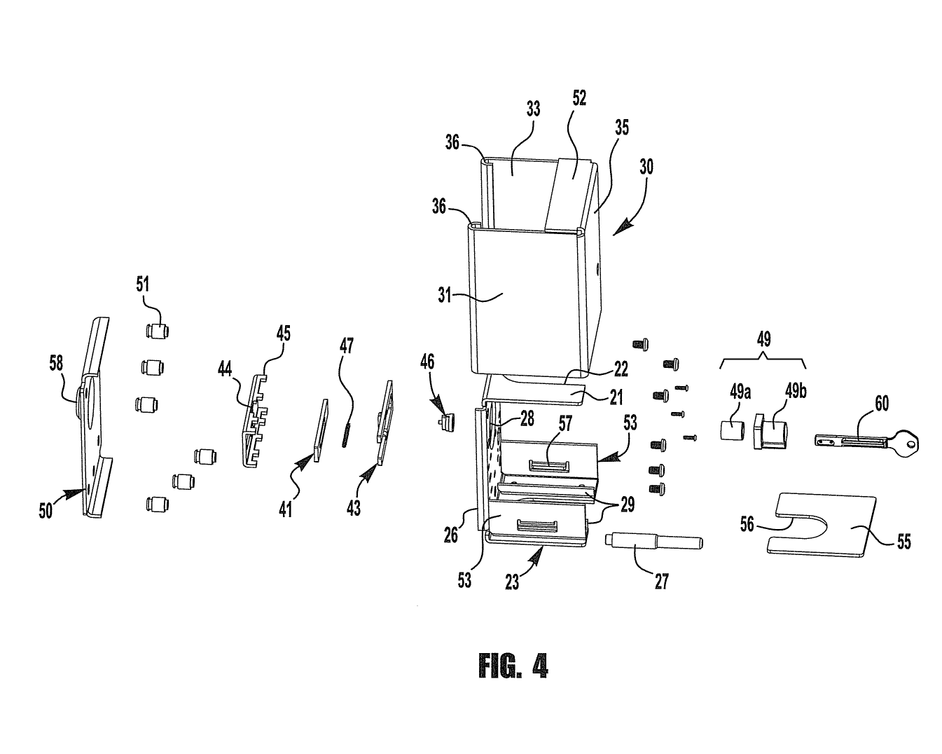

The frame member 20 and shroud member 30 may be provided with one or more features configured to secure a valve within the enclosure. For example, as shown in FIGS. 3 and 4, a post 27 may be affixed to the rear wall 25 of the frame member 20 for insertion through a corresponding aperture in the valve body or handle. In one example, as shown in FIG. 8, a conventional gas valve V includes a handle H and bracket B with lock apertures A1, A2 that align in a shutoff position (not shown) to receive a padlock shackle to lock the handle H in the shutoff position. When assembling the lockout device 10 to such a valve V, the post 27 may be inserted through one or both of these lock apertures A1, A2 to secure the valve V in place within the enclosure and to further impede operation of the valve handle H. As another example, the rear wall 25 may be provided with an opening 28 (FIGS. 3 and 5) or a recessed portion sized to accommodate the valve body, and further impeding movement of the installed device 10 with respect to the valve.

The frame member 20 and shroud member 30 may also be configured to resist prying apart the frame and shroud members, or other such “brute force” attacks or tampering with the lockout device 10, for example, by reinforcing the walls defining the lockout enclosure. As one example, the shroud member 30 may be provided with one or more flanges 52 extending laterally from the front wall adjacent to one or both of the top and bottom walls 21, 23 of the frame member 20. As another example, the frame member 20 may be provided with side wall supports 53 secured to one or both of the top and bottom walls 21, 23 to reinforce the side walls 31, 33. As shown, the side wall supports 53 may include integral gussets 29 provided as bent flanges and aligned with the sides of the cut-out portion 22 to reinforce the sides of the conduit opening.

The frame member cut-out portions 22, 24 and the front wall 35 of the shroud member 30 may together define first and second openings for receiving the valve conduits C1, C2 therethrough. In other embodiments, the openings may be further defined or restricted to limit movement of the lockout device on the valve assembly. As one example, the shroud member flange or flanges 52 may partially define and further reduce the size of one or both of the first and second openings. As another example, one or more adapter plates 55 (see FIG. 4) may be provided to further restrict the valve conduit C1, C2 between the adapter plate and the top or bottom wall portions 21,23. The adapter plate 55 may, but need not, include a cut-out 56 shaped to more closely receive the valve conduit. While the adapter plate 55 may be secured to the frame member 20 and/or shroud member 30 in a variety of suitable arrangements, in the illustrated embodiment, an adapter plate 55 is received in the frame member 20 on a shelf portion defined by bent tabs 57 (FIGS. 3 and 4) extending from side wall supports 53 of the frame member 20. The valve lockout device 10 may be provided with multiple adapter plates 55 having different sized cut-outs to accommodate different sized conduits C1, C2.

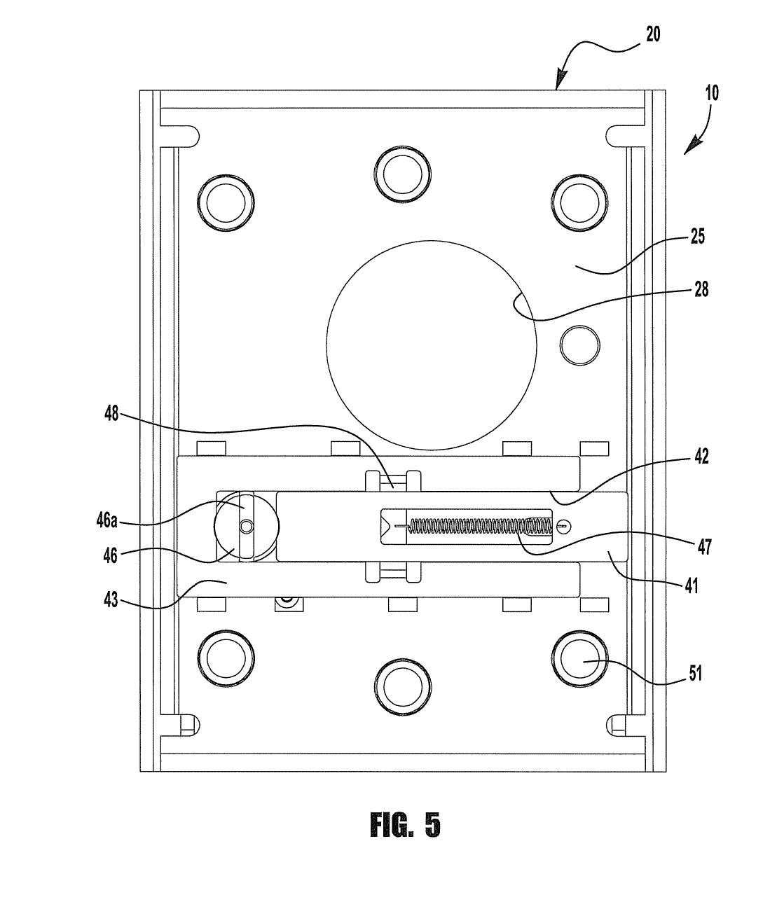

Many different locking mechanisms may be utilized to secure the shroud member to the frame member for locked enclosure of the valve. In one embodiment, one or more lock bars or other such locking members assembled with the frame member are movable to interlock with the shroud member for locked retention of the shroud member on the frame member. In the illustrated embodiment, a locking mechanism includes first and second lock bars 41, 43 that extend through corresponding notches 32, 34 (FIG. 6) in the slotted bearing portions 36 of the shroud member 30 to secure the shroud member against sliding movement. The lock bars 41, 43 are disposed between the rear wall 25 of the frame member 20 and a back plate 50 secured to the rear wall 25 by standoff pins 51, which may be welded or riveted to attach the back plate 50 to the rear wall. As shown in FIG. 4, the lock bars 41, 43 may be retained within a latch cover 44 secured to the rear wall 25 (for example, by tabs 45 crimped or otherwise secured through slots in the rear wall). The back plate 50 may be provided with a raised boss 58 that aligns with the rear wall opening 28 to provide additional clearance for the locked out valve.

In the illustrated embodiment, the locking mechanism utilizes a nested lock bar arrangement, in which the second lock bar 43 includes a cutout 42 sized to receive the first lock bar 41 (see FIGS. 4 and 5). In such an arrangement, the second lock bar 43 may include a larger notch-engaging portion than that of the first lock bar 41, and the corresponding shroud notches 34, 32 may be sized accordingly. The locking mechanism further includes a locking cam 46 extending between the first and second lock bars 41, 43. The locking cam 46 is rotatable between a locked position, in which an oblong projection 46a of the locking cam 46 forces the first and second lock bars 41, 43 outward into locking engagement with the shroud notches 32, 34, and an unlocked position, in which the locking cam 46 permits the first and second lock bars 41, 43 to move inward and out of engagement with the notches 32, 34. The lock bars 41, 43 may be spring biased inward for automatic disengagement of the shroud member 30 from the frame member 20 upon rotation of the locking cam 46. In the illustrated embodiment, a tension spring member 47 is connected to the first lock bar 41 and to the second lock bar 43 (at cross bar 48) for inward biasing of the first and second lock bars.

The device 10 further includes a lock interface for rotation of the locking cam 46 from the locked position to the unlocked position upon proper manipulation of the lock interface. In the illustrated embodiment, the lock interface includes a key cylinder 49 (as known in the art) having a cylinder plug 49a rotationally fixed to the locking cam 46 (e.g., by a tang or other protrusion extending from the plug), such that insertion of an authorized key through an aligned opening or lock access aperture 39 in the front wall 35 of shroud 30 and into the cylinder plug 49a permits rotation of the locking cam 46 between locked and unlocked positions. While the key cylinder 49 may be positioned proximate the shroud opening 39, in the illustrated embodiment, the key cylinder shell 49b is affixed to the rear wall 25 of the frame member 20, such that the keyway is recessed from the shroud opening 39 or spaced apart from the shroud opening by a portion of the enclosure. The resulting offset between the shroud opening 39 and the key cylinder 49 may serve to impede picking, bumping the key cylinder lock, or other such attacks. While any suitable offset may be provided, in one embodiment, an offset distance of at least two inches (e.g., 2.5 inches) is provided between the access aperture 39 and the key cylinder 49. Accordingly, an authorized key for use with the lockout device 10 may be provided with an extended key flat to reach the offset key cylinder 49 when inserted through the shroud opening 39. In another embodiment, an extension tool 60, as shown in FIG. 4, may be provided for attachment to a standard key, with the extension tool 60 being sized to span the offset space between the shroud opening 39 and the key cylinder 49.

While the valve lockout device may be provided in any suitable material, in one embodiment, the components of the lockout device include high strength metals to withstand attack and resist corrosion, including, for example, common steel carbonitride case hardened to 53/58 HRC.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

We claim:

1. A lockout device for restricting access to an item, the device comprising:
a frame member;
a shroud member configured to be assembled with the frame member, the frame member and shroud member defining an enclosure sized to enclose the item; and
a locking mechanism secured to the frame member, the locking member being operable between a locked condition in which the shroud member is secured to the frame member, and an unlocked condition in which the shroud member is removable from the frame member to access the item;
wherein the shroud member includes a lock access aperture aligned with a lock interface of the locking mechanism when the shroud member is assembled with the frame member, the lock interface being spaced apart from the lock access aperture by a portion of the shroud member to inhibit tampering with the lock interface.

2. The lockout device of claim 1, wherein the lock interface comprises a key cylinder lock.

3. The lockout device of claim 1, wherein the shroud member is assembled with the frame member by sliding engagement of the shroud member with the frame member.

4. The lockout device of claim 1, wherein the frame member comprises side flanges receivable in slotted bearing portions of the shroud member for sliding engagement therewith.

5. The lockout device of claim 1, wherein the locking mechanism comprises at least one lock bar that extends into a corresponding recess in the shroud member when the locking mechanism is in the locked condition, the at least one lock bar being retractable from the corresponding recess when the locking mechanism is in the unlocked condition.

6. The lockout device of claim 1, wherein the locking mechanism comprises nested first and second lock bars connected by a tension spring member to spring bias the first and second lock bars toward a retracted position, the locking mechanism further comprising a locking cam configured to force the first and second lock bars outward into an extended position when the locking mechanism is in the locked condition.

7. The lockout device of claim 1, further comprising a back plate secured to a rear wall of the frame member, wherein at least a portion of the locking mechanism is disposed between the rear wall and the back plate.

8. The lockout device of claim 1, wherein the lockout device is configured to restrict access to a valve having a first port connected with a first conduit and a second port connected with a second conduit, wherein the enclosure is sized to retain the valve, and at least one of the frame member and shroud member at least partially defines a first opening positioned to receive the first conduit therethrough, and at least partially defines a second opening positioned to receive the second conduit therethrough.

9. The lockout device of claim 8, further comprising an adapter plate configured to be assembled with the frame member to at least partially define the first opening, the adapter plate being configured to provide reduced clearance between the valve lockout device and the first conduit when the valve lockout device is assembled with the valve.

10. The lockout device of claim 8, wherein the frame member comprises an upper wall at least partially defining the first opening, and a lower wall at least partially defining the second opening, and the shroud member comprises a front wall defining the lock access aperture, and first and second side walls configured to engage the frame member.

11. The lockout device of claim 18, further comprising an extension tool assembled with a key configured to operate the key cylinder lock, the extension tool being insertable into the lock access aperture and sized to span the portion of the enclosure between the lock access aperture and the key cylinder lock for insertion of the key into the key cylinder lock.

12. A valve lockout device for mounting with a valve having a first port connected with a first conduit and having a second port connected with a second conduit, the device comprising:
a frame member configured to be secured to the valve;
a shroud member configured to be assembled in sliding engagement with the frame member, the frame member and shroud member defining an enclosure sized to enclose the valve, at least one of the frame member and shroud member defining a first opening positioned to receive the first conduit therethrough, and a second opening positioned to receive the second conduit therethrough; and
a locking mechanism secured to one of the frame member and the shroud member, the locking member being operable between a locked condition in which the shroud member is secured to the frame member, and an unlocked condition in which the shroud member is removable from the frame member to access the valve when the valve lockout device is installed on the valve;
wherein the locking mechanism comprises at least one locking member that extends into a corresponding recess in the other of the frame member and the shroud member when the locking mechanism is in the locked condition, the at least one locking member being retractable from the corresponding recess when the locking mechanism is in the unlocked condition.

13. The valve lockout device of claim 12, wherein the locking mechanism comprises first and second locking members connected by a tension spring member to bias the first and second locking members toward a retracted position, the locking mechanism further comprising a locking cam configured to force the first and second locking members outward into an extended position when the locking mechanism is in the locked condition.

14. The valve lockout device of claim 12, wherein the frame member comprises an upper wall at least partially defining the first opening, and a lower wall at least partially defining the second opening, and the shroud member comprises a front wall defining the lock access aperture, and first and second side walls configured to engage the frame member.

15. The valve lockout device of claim 14, wherein the shroud member comprises a bottom flange extending laterally from the front wall to partially define one of the first and second openings.

16. The valve lockout device of claim 12, wherein the sliding engagement between the shroud member and the frame member is in a direction substantially perpendicular to the first opening.

17. The valve lockout device of claim 12, wherein the frame member comprises a post positioned to extend through an aperture in a handle of a valve when the valve lockout device is mounted with the valve and the valve handle is in a closed position, such that the post prevents movement of the valve handle out of the closed position.

18. In combination, a valve assembly and valve lockout device, the valve assembly including a valve body, a valve handle for operating the valve, and first and second ports connected with corresponding first and second conduits, the valve lockout device comprising:
a frame member secured to the valve;
a shroud member assembled with the frame member, the frame member and shroud member defining an enclosure enclosing the valve, with at least one of the frame member and shroud member at least partially defining a first opening receiving the first conduit therethrough, and a second opening receiving the second conduit therethrough; and
a locking mechanism secured to the frame member, the locking mechanism being operable between a locked condition in which the shroud member is secured to the frame member, and an unlocked condition in which the shroud member is removable from the frame member to access the valve.

19. The combination of claim 18, wherein the valve handle comprises an aperture, and the frame member comprises a post positioned to extend through the aperture when the valve handle is in a closed position, thereby preventing movement of the valve handle out of the closed position.

20. The combination of claim 18, wherein the locking mechanism includes a key cylinder lock, and the shroud member includes a lock access aperture aligned with the key cylinder lock and spaced apart from the key cylinder lock by a portion of the enclosure to inhibit tampering with the key cylinder lock.

21. The combination of claim 18, wherein the valve lockout device further comprises an adapter plate configured to be assembled with the frame member to at least partially define the first opening, the adapter plate providing reduced clearance between the valve lockout device and the first conduit.

22. The combination of claim 18, wherein the frame member comprises side flanges receivable in slotted bearing portions of the shroud member for sliding engagement therewith.
